(19) United States
(12) Patent Application Publication
(10) Pub. No.: US 2016/0368782 A1
(43) Pub. Date: Dec. 22, 2016

(54) MONITORING CONTROL DEVICE, WATER TREATMENT SYSTEM INCLUDING SAME, AND WATER TREATMENT METHOD

(71) Applicant: Hitachi, Ltd., Tokyo (JP)

(72) Inventors: Hiroto YOKOI, Tokyo (JP); Hiroki YAMAMOTO, Tokyo (JP); Takeyuki KONDOU, Tokyo (JP)

(21) Appl. No.: 15/176,509

(22) Filed: Jun. 8, 2016

(30) Foreign Application Priority Data
Jun. 19, 2015 (JP) 2015-123402

(51) Int. Cl. C02F 1/00; G01N 27/42; G05D 11/13; C02F 1/44

(52) U.S. Cl. CPC C02F 1/008; C02F 1/441; C02F 1/442; G01N 27/42; G05D 11/138; C02F 2209/19; C02F 2209/40; C02F 2101/101

(57) ABSTRACT

A water treatment system includes a water treatment facility which includes a sulfate ion removing unit removing sulfate ions of treatment object water introduced from an inflow pipe and including an oil component and supplying treatment water after removing the sulfate ions to an outflow pipe and a bypass pipe branching off from the inflow pipe and causing the treatment object water to circulate through the outflow pipe, and a monitoring control device which includes a monitoring unit measuring a sulfate ion concentration of the treatment object water including the oil component and a flow rate control unit calculating a supply flow rate of the treatment object water to the sulfate ion removing unit and a supply flow rate of the treatment object water to the bypass pipe, on the basis of the sulfate ion concentration obtained by the monitoring unit.

### CLAIM OF PRIORITY

The present application claims priority from Japanese Patent application serial No.2015-123402, filed on Jun. 19, 2015, the content of which is hereby incorporated by reference into this application.

### BACKGROUND OF THE INVENTION

1. Field of the Invention

The present invention relates to a water treatment system for enhanced oil recovery (EOR) and more particularly, to a monitoring control device capable of appropriately managing a concentration of sulfate ions of treatment object water, a water treatment system including the same, and a water treatment method.

2. Description of the Related Art

As a method of extracting crude oil from an oil layer, flush production using a pressure stored in bedrock is used conventionally. However, recently, various extraction methods are developed for the purpose of improving a recovery rate of the crude oil. These are called EOR and a water flood or a chemical flood exists as a representative example thereof. The water flood is a method of pressing water into the oil layer to give oil scavenging energy artificially, maintaining productivity, and improving an ultimate recovery factor greatly. In addition, the chemical flood to be an improvement of the water flood is a general term of methods of pressing chemical drugs or a mixture thereof into the oil layer and improving the recovery factor of the crude oil. However, the chemical flood is classified into a surfactant flood, a polymer flood, and a caustic flood by the used drugs and principles of improvement of recovery factors thereof are different from each other. The surfactant flood is a method of pressing a series of fluids including a solution using a surfactant as a main component into the oil layer to decrease interfacial tension between the crude oil and the water, extracting the crude oil captured by capillary action, and recovering the crude oil.

The management of the quality of the water used in these methods is an important element that is directly linked to an amount of production. For example, because suspended solids (SS) become a factor to close pores of oil rock or pipes becoming paths which the crude oil passes through, a particle diameter and a concentration are managed. In addition, because a basement is under a reduction atmosphere, a dissolved oxygen concentration is managed to maintain the reduction atmosphere and suppress precipitation of an oxide. Also, sulfate ions that are combined with alkaline-earth metal elements such as Ba and Sr included in the underground and form a sulfate solid become one of management items. The sulfate ions are mainly mixed when seawater is desalted and is applied to EOR. As a method of removing the sulfate ions of the water, a nano-filtration (NF) film is introduced recently. Because the NF film has low pressure loss relating to membrane permeation as compared with an RO film to desalt NaCl, the NF film can manage the sulfate ions simply with relatively low energy. For example, JP-9-141260-A discloses technology for removing a large part of sulfate ions (SO₄⁻⁻) of the seawater as magnesium sulfate (MgSO₄) by disposing the NF film on a front step of the RO film and causing the sulfate ions of the seawater to permeate the NF film, in a seawater desalination system. Thereby, precipitation of a scale in the RO film disposed on a rear step, that is, precipitation of calcium sulfate is suppressed.

### SUMMARY OF THE INVENTION

However, JP-9-141260-A discloses the seawater desalination system in which the NF film is disposed on the front step of the RO film, but does not disclose control of a running management method thereof with respect to a target water quality. For this reason, if constant running is performed, NF film treatment is always performed on the treatment object water, even when a quality of raw water to be the treatment object water changes and the sulfate ion concentration of the treatment object water decreases. Therefore, fouling of the NF film is accelerated or the fouling is suppressed. For this reason, if film washing is performed with a drug for every predetermined running period, a material of the NF film is deteriorated and a life of the NF film is decreased.

In the case in which the technology described in JP-9-141260-A is applied to EOR, if a facility becomes a large-scale facility in which a supply amount of water used for EOR is several tens of thousands m³/d, an initial cost relating to an NF film treatment facility increases and the life of the NF film to be a consumable supply is decreased, so that a running cost increases, which results in increasing an oil production cost.

Accordingly, the present invention provides a monitoring control device capable of increasing a life of a sulfate ion removing unit to remove sulfate ions of treatment object water, a water treatment system including the same, and a water treatment method.

An aspect of the present invention provides a water treatment system including a water treatment facility which includes a sulfate ion removing unit removing sulfate ions of treatment object water introduced from an inflow pipe and including at least an oil component and supplying treatment water after removing the sulfate ions to an outflow pipe and a bypass pipe branching off from the inflow pipe and causing the treatment object water including the oil component to circulate through the outflow pipe and a monitoring control device which includes a monitoring unit measuring a sulfate ion concentration of the treatment object water including the oil component and/or a sulfate ion concentration of the treatment water circulating through the outflow pipe and a flow rate control unit controlling a supply flow rate of the treatment object water to the sulfate ion removing unit and a supply flow rate of the treatment object water to the bypass pipe, wherein the flow rate control unit calculates the supply flow rate of the treatment object water to the sulfate ion removing unit and the supply flow rate of the treatment object water to the bypass pipe, on the basis of the sulfate ion concentration obtained by the monitoring unit.

Another aspect of the present invention provides a monitoring control device for controlling a water treatment facility including a sulfate ion removing unit removing sulfate ions of treatment object water introduced from an inflow pipe and including at least an oil component and supplying treatment water after removing the sulfate ions to an outflow pipe and a bypass pipe branching off from the inflow pipe and causing the treatment object water including the oil component to circulate through the outflow pipe, the monitoring control device including a monitoring unit which measures a sulfate ion concentration of the treatment object water including the oil component and/or a sulfate ion concentration of the treatment water circulating through the outflow pipe, and a flow rate control unit which controls a supply flow rate of the treatment object water to the sulfate ion removing unit and a supply flow rate of the treatment object water to the bypass pipe, wherein the flow rate control unit calculates the supply flow rate of the treatment object water to the sulfate ion removing unit and the supply flow rate of the treatment object water to the bypass pipe, on the basis of the sulfate ion concentration obtained by the monitoring unit.

A further aspect of the present invention provides a water treatment method for a water treatment facility including a sulfate ion removing unit removing sulfate ions of treatment object water introduced from an inflow pipe and including at least an oil component and supplying treatment water after removing the sulfate ions to an outflow pipe, and a bypass pipe branching off from the inflow pipe and causing the treatment object water including the oil component to circulate through the outflow pipe, the water treatment method including measuring a sulfate ion concentration of the treatment object water including the oil component and/or a sulfate ion concentration of the treatment water circulating through the outflow pipe and calculating a supply flow rate of the treatment object water to the sulfate ion removing unit and a supply flow rate of the treatment object water to the bypass pipe, on the basis of the measured sulfate ion concentration.

The present invention can provide a monitoring control device capable of increasing a life of a sulfate ion removing unit to remove sulfate ions of treatment object water, a water treatment system including the same, and a water treatment method.

For example, a sulfate ion concentration is monitored online and minimum sulfate ions satisfying a target water quality are treated by the sulfate ion removing unit on the basis of a monitoring result. Therefore, a load of the sulfate ion removing unit can be alleviated and the sulfate ion removing unit can be used over a long period.

### BRIEF DESCRIPTION OF THE DRAWINGS

Other objects and advantages of the invention will become apparent from the following description of embodiments with reference to the accompanying drawings in which:

FIG. 1 is a schematic entire configuration diagram of a water treatment system according to a first embodiment of the present invention;

FIG. 2 is a functional block diagram of a flow rate control unit configuring a monitoring control device illustrated in FIG. 1;

FIG. 3 is a control flow diagram of a water treatment facility by the monitoring control device illustrated in FIG. 1;

FIG. 4 is a schematic entire configuration diagram of a modification of the water treatment system according to the first embodiment illustrated in FIG. 1;

FIG. 5 is a schematic entire configuration diagram of a water treatment system according to a second embodiment of the present invention;

FIG. 6 is a control flow diagram of a water treatment facility by a monitoring control device illustrated in FIG. 5;

FIG. 7 is a schematic entire configuration diagram of a water treatment system according to a third embodiment of the present invention;

FIG. 8 is a schematic entire configuration diagram of a water treatment system according to a fourth embodiment of the present invention; and

FIG. 9 is a schematic entire configuration diagram of a water treatment system according to a fifth embodiment of the present invention.

### DESCRIPTION OF THE PREFERRED EMBODIMENTS

In the present specification, a water treatment system according to an embodiment uses produced water, seawater, or brackish water as treatment object water. Hereinafter, description is given on the assumption that a water treatment facility configuring the water treatment system is applied to EOR. Therefore, the produced water, that is, the treatment object water including at least an oil component is described as a treatment object. However, the present invention is not limited thereto.

In addition, in the present specification, the water treatment facility described below includes a pretreatment unit and a posttreatment unit not illustrated in the drawings. As an example of the pretreatment unit, a flocculation tank to add a flocculation agent to the treatment object water including at least the oil component, capture suspended solids (SS) such as organic matters in the treatment object water by the flocculation agent, and form flocks or a pH adjusting unit to add a pH adjuster to the treatment object water and adjust pH of the treatment object water is appropriately provided according to necessity. As an example of the posttreatment unit, a facility to cause treatment water from which sulfate ions have been removed or treatment water from which sulfate ions have been reduced, complying with water quality standards, to permeate a film separator such as an RO film and perform desalination or a device to execute a treatment for injecting the treatment water from which the sulfate ions have been reduced into an oil layer, not illustrated in the drawings, is appropriately provided according to necessity.

In addition, in the present specification, both treatment water introduced into a treatment water tank after the sulfate ions of the treatment object water including the oil component are removed by a sulfate ion removing unit to be described below and treatment object water introduced into the treatment water tank via a bypass pipe without circulating through the sulfate ion removing unit may be called treatment water. That is, in the present specification, water introduced into the treatment water tank is called the treatment water, regardless of whether the water circulates through the sulfate ion removing unit.

Preferred embodiments of the present invention will be described in detail below with reference to the accompanying drawings, wherein like reference numerals refer to like parts throughout.

### First Embodiment

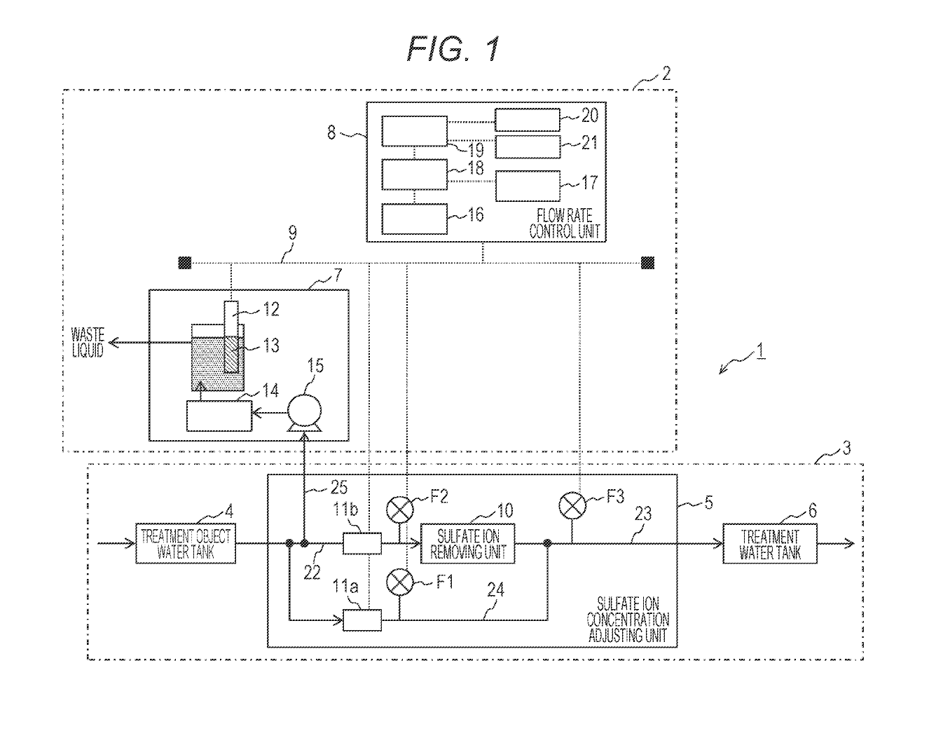

FIG. 1 is a schematic entire configuration diagram of a water treatment system according to a first embodiment of the present invention. As illustrated in FIG. 1, a water treatment system 1 includes a water treatment facility 3 and a monitoring control device 2 to control the water treatment facility 3.

The water treatment facility 3 has a treatment object water tank 4 to temporarily store treatment object water including an oil component from the upstream side thereof along a flow of the treatment object water including at least the oil component, a sulfate ion concentration adjusting unit 5 to adjust a concentration of sulfate ions of the treatment object water including the oil component, and a treatment water tank 6 to temporarily store treatment water after adjustment of the concentration of the sulfate ions. As described above, the treatment object water from which SS have been removed by a flocculation tank not illustrated in the drawings or the treatment object water after pH adjustment flows into the treatment object water tank 4. In addition, the treatment water stored in the treatment water tank 6 is supplied to a device to execute a desalination treatment by an RO film not illustrated in the drawings in a rear step or a facility to inject the treatment water into an oil layer for EOR.

The sulfate ion concentration adjusting unit 5 has a sulfate ion removing unit 10 that is connected to the treatment object water tank 4 via an inflow pipe 22 and an outflow pipe 23 that supplies treatment water from which the sulfate ion concentration of the treatment object water has been adjusted by the sulfate ion removing unit 10 to the treatment water tank 6. Further, the sulfate ion concentration adjusting unit 5 has a flow meter F2 to measure a flow rate of the treatment object water including the oil component flowing into the sulfate ion removing unit 10 via the inflow pipe 22, which is attached thereto. In addition, the sulfate ion concentration adjusting unit 5 has a flow rate adjusting unit 11b that is provided at the upstream side of the flow meter F2 of the inflow pipe 22 and a bypass pipe 24 that branches off from the inflow pipe 22 of the upstream side of the flow rate adjusting unit 11b and causes the treatment object water to be supplied to the outflow pipe 23 without circulating through the sulfate ion removing unit 10. A flow meter F1 to measure a flow rate of the treatment object water circulating through the bypass pipe 24 is attached to the bypass pipe 24 and a flow rate adjusting unit 11a is provided at the upstream side of the flow meter F1 of the bypass pipe 24. In the outflow pipe 23, a flow meter F3 to measure a flow rate of the treatment water, which is supplied to the treatment water tank 6 and of which the sulfate ion concentration has been adjusted by the sulfate ion removing unit 10, and/or the treatment object water circulating through the bypass pipe 24 is attached to the downstream side of a joining portion with the bypass pipe 24. In addition, the sulfate ion concentration adjusting unit 5 includes a sampling pipe 25 that branches off from the inflow pipe 22 between a branching portion of the bypass pipe 24 and the flow rate adjusting unit 11b and introduces a part of the treatment object water including the oil component to a monitoring unit 7 configuring the monitoring control device 2 to be described below. A branching portion of the sampling pipe 25 from the inflow pipe 22 is not limited thereto and may be provided at the upstream side of the branching portion of the bypass pipe 24 from the inflow pipe 22.

Here, the sulfate ion removing unit 10 is configured using a treatment of the NF film, the RO film, flocculation and settlement, or an ion exchange. The flow rate adjusting units 11a and 11b are realized by pumps and/or valves. The pumps and/or the valves used as the flow rate adjusting units 11a and 11b need to have a specification to supply a water amount/water pressure enabling at least the treatment of the sulfate ion removing unit 10. In this embodiment, the pumps capable of performing non-step flow rate adjustment by inverters are assumed as the flow rate adjusting units 11a and 11b. The flow meters F1, F2, and F3 measure a flow rate of the treatment object water supplied to the bypass pipe 24 and including the oil component, a flow rate of the treatment object water supplied to the sulfate ion removing unit 10 and including the oil component, and a flow rate of the treatment water supplied to the treatment water tank 6 via the outflow pipe 23 after joining, respectively.

As illustrated in FIG. 1, the monitoring control device 2 includes a monitoring unit 7 that measures the sulfate ion concentration of the treatment object water introduced via the sampling pipe 25 and including the oil component, with a predetermined cycle, and a flow rate control unit 8 that controls the flow rate adjusting units 11a and 11b, on the basis of measurement values of the flow meters F1 to F3 and the sulfate ion concentration measured by the monitoring unit 7. Further, the monitoring control device 2 includes a network 9 that connects the monitoring unit 7, the flow rate control unit 8, the individual flow meters F1 to F3, and the flow rate adjusting units 11a and 11b to enable communication. The measurement values of the flow meters F1 to F3 are continuously transmitted to the flow rate control unit 8 via the network 9.

The monitoring unit 7 includes an electrode 12 for sulfate ion detection, a sulfate ion selective permeation film 13, a pretreatment unit 14, and a sampling pump 15 attached to the sampling pipe 25. As an example of the electrode 12 for the sulfate ion detection, an Ag/AgCl electrode can be used. The electrode 12 for the sulfate ion detection is used in a KCl solution. In addition, the sulfate ion selective permeation film is a generic term of fat-soluble molecules having the ability of increasing permeability of specific ions in ionophore, that is, a biological film. In this embodiment, 1,3-[Bis(3-phenylthioureidomethyl)] benzene can be used as a material enabling selective permeation of only the sulfate ions. A treatment object by the pretreatment unit 14 is an organic matter including the SS component and the oil component of the treatment object water including the oil component, which is introduced via the sampling pipe 25 by the sampling pump 15. The SS component is removed by a film treatment of a micro-filtration (MF) film, settling, or a flocculation and settlement treatment. Meanwhile, when the organic matter including the oil component is removed, active carbon, an oily water separation film, flocculation and settlement, or ozone can be applied. In addition, when a salt or sulfate ion concentration of the treatment object water including the oil component or a water quality target value of the sulfate ions is beyond a concentration region where measurement is enabled by the monitoring unit 7, a dilution device to dilute the treatment object water with pure water is provided. Thereby, the sulfate ion concentration can be measured appropriately and control precision by the flow rate control unit 8 is improved. The sampling pump 15 collects the treatment object water including the oil component introduced from the sampling pipe 25 continuously by an amount of water in which the pretreatment and electrochemical sulfate ion concentration measurement are enabled. As such, the monitoring unit 7 electrochemically measures a concentration of the sulfate ions included in a part of the treatment object water including the oil component introduced via the sampling pipe 25.

As described above, the pretreatment unit 14 configuring the monitoring unit 7 is provided to introduce the part of the treatment object water including the oil component via the sampling pipe 25 and measure the sulfate ion concentration of the treatment object water with high precision. Therefore, the pretreatment unit 14 is not an essential configuration but an auxiliary configuration and the pretreatment unit 14 may be omitted. That is, the sulfate ion concentration of the treatment object water including the oil component introduced via the sampling pipe 25 and the sampling pump 15 may be measured directly by the electrode 12 for the sulfate ion detection and the sulfate ion selective permeation film 13.

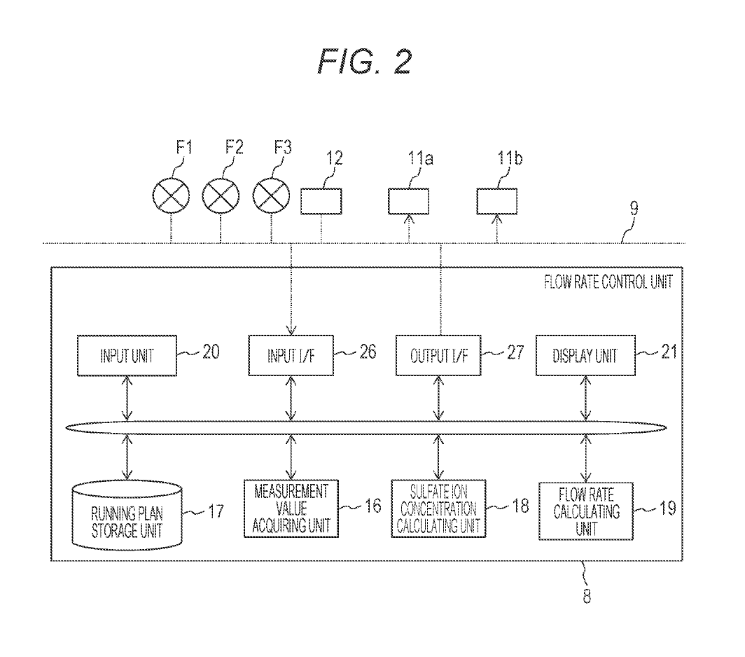

The flow rate control unit 8 includes a measurement value acquiring unit 16, a running plan storage unit 17, a sulfate ion concentration calculating unit 18, a flow rate calculating unit 19, an input unit 20, and a display unit 21. FIG. 2 is a functional block diagram of the flow rate control unit 8 configuring the monitoring control device 2. As illustrated in FIG. 2, the flow rate control unit 8 has an input I/F 26 and an output I/F 27 in addition to the above configuration and these elements are electrically connected to each other by an internal bus.

The running plan storage unit 17 stores at least a sulfate ion reference value (sulfate ion water quality target value), a treatment amount plan value (planned treatment flow rate), and removal performance (removal rate) of the sulfate ion removing unit 10, among water quality target values of the treatment water by the sulfate ion concentration adjusting unit 5, which are previously input by an operator via the input unit 20. In this embodiment, an example of the case in which the removal performance (removal rate) of the sulfate ion removing unit 10 is set to a constant rate without depending on a water quality or an inflow amount of the treatment object water including the oil component flowing into the sulfate ion removing unit 10 via the inflow pipe 22 is described. However, when the flocculation and settlement or ion exchange treatment is used, the removal performance (removal rate) of the sulfate ion removing unit 10 may be stored as a function thereof.

The measurement value acquiring unit 16 acquires measurement values of the flow rates and a measurement value of the sulfate ion concentration from the flow meters F1 to F3 and the monitoring unit 7 (electrode 12 for the sulfate ion detection) via the network 9, the input I/F 26, and the internal bus. The sulfate ion concentration calculating unit 18 calculates a prediction value of a sulfate ion concentration in an outflow portion of the sulfate ion removing unit 10, on the basis of information which is stored in the running plan storage unit 17 and the measurement value of the sulfate ion concentration by the monitoring unit 7 which is acquired by the measurement value acquiring unit 16.

The flow rate calculating unit 19 calculates a flow rate of the treatment object water including the oil component supplied to the bypass pipe 24 and a flow rate of the treatment object water including the oil component supplied to the sulfate ion removing unit 10 via the inflow pipe 22, on the basis of the sulfate ion water quality target value and the planned treatment flow rate which are stored in the running plan storage unit 17, the measurement value of the sulfate ion concentration by the monitoring unit 7 which is acquired by the measurement value acquiring unit 16, and the prediction value of the sulfate ion concentration in the outflow portion of the sulfate ion removing unit 10 which is calculated by the sulfate ion concentration calculating unit 18. In addition, the flow rate calculating unit 19 outputs a control amount of the flow rate adjusting unit 11a corresponding to the calculated flow rate of the treatment object water to the bypass pipe 24 as a command value to the flow rate adjusting unit 11a via the output I/F 27. Likewise, the flow rate calculating unit 19 outputs a control amount of the flow rate adjusting unit 11b corresponding to the calculated flow rate of the treatment object water to the sulfate ion removing unit 10 as a command value to the flow rate adjusting unit 11 via the output I/F 27.

When the prediction value of the sulfate ion concentration in the outflow portion of the sulfate ion removing unit 10 calculated by the sulfate ion concentration calculating unit 18 is more than the sulfate ion water quality target value stored in the running plan storage unit 17, the display unit 21 displays a warning and informs the operator of corresponding information. In addition, the display unit 21 displays the flow rate of the treatment object water to the bypass pipe 24 and the flow rate of the treatment object water to the sulfate ion removing unit 10, which are calculated the flow rate calculating unit 19. As a result, the operator can easily grasp the flow rates of the treatment object water distributed to the sulfate ion removing unit 10 and the bypass pipe 24.

As such, the flow rate control unit 8 determines the flow rates of the treatment object water distributed to the sulfate ion removing unit 10 and the bypass pipe 24, on the basis of the measurement value of the sulfate ion concentration of the treatment object water by the monitoring unit 7, the prediction value of the sulfate ion concentration in the outflow portion of the sulfate ion removing unit 10, and the previously set sulfate ion water quality target value and planned treatment flow rate.

The measurement value acquiring unit 16, the sulfate ion concentration calculating unit 18, and the flow rate calculating unit 19 configuring the flow rate control unit 8 are realized by a storage unit (not illustrated in the drawings) such as a ROM storing various programs to execute the operation and a RAM temporarily storing an operation result or a result in the course of the operation and a processor such as a CPU reading the various programs stored in the ROM and executing the various programs. In some cases, the various programs and the operation result or the result in the course of the operation may be stored in a specific storage area in the running plan storage unit 17, instead of the ROM and the RAM.

In this embodiment, in the monitoring unit 7, an electrochemical method is applied as the method of measuring the sulfate ions. However, the method is not limited in particular, as long as measurement is enabled with the frequency necessary for controlling the sulfate ion concentration adjusting unit 5. For example, measurement method of measuring turbidity by precipitating barium sulfate or analysis by ion chromatograph may be used. The measurement frequency depends on a cycle of a water quality change of the flowing treatment object water including the oil component. However, the measurement is preferably enabled with the frequency at least ten times higher than the control frequency (inverse number of a control cycle) of the sulfate ion concentration adjusting unit 5. Here, the control frequency of the sulfate ion concentration adjusting unit 5 is set to about 1/hr and the control frequency preferably increases.

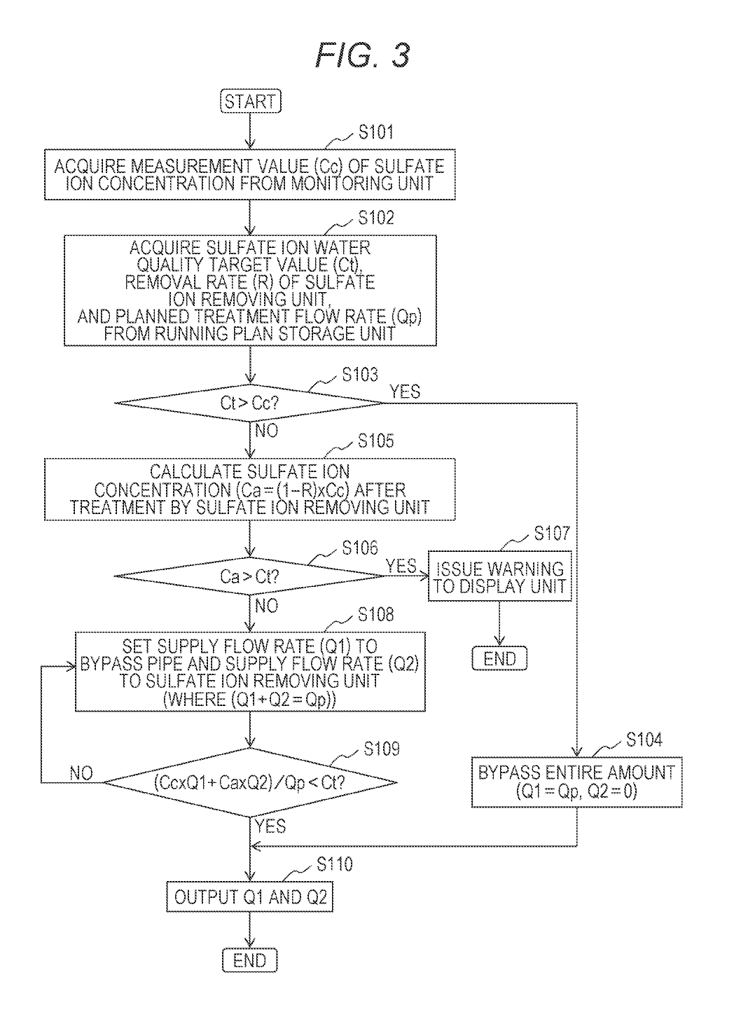

FIG. 3 is a control flow diagram of the water treatment facility 3 by the monitoring control device 2 illustrated in FIG. 1. First, the measurement value acquiring unit 16 configuring the flow rate control unit 8 acquires a measurement value Cc [mg/L] of a current sulfate ion concentration of the treatment object water from the monitoring unit 7 via the network 9 (step S101). Next, the sulfate ion concentration calculating unit 18 configuring the flow rate control unit 8 refers to the running plan storage unit 17 via the internal bus and acquires a sulfate ion water quality target value Ct [mg/L], a removal rate R [−] of the sulfate ion removing unit 10, and a planned treatment flow rate Qp [m³/d] stored in the running plan storage unit 17 (step S102). In step S103, the sulfate ion concentration calculating unit 18 compares the sulfate ion water quality target value Ct and the measurement value Cc of the current sulfate ion concentration of the treatment object water and determines whether the measurement value Cc of the current sulfate ion concentration of the treatment object water is less than the sulfate ion water quality target value Ct. As a determination result, if the measurement value Cc of the current sulfate ion concentration is less than the sulfate ion water quality target value Ct, the sulfate ion concentration of the treatment object water satisfies the water quality target value when the treatment object water including the oil component flows into the water treatment facility 3. Therefore, the treatment by the sulfate ion removing unit 10 becomes unnecessary. For this reason, the sulfate ion concentration calculating unit 18 outputs information showing that the measurement value Cc of the current sulfate ion concentration of the treatment object water is less than the sulfate ion water quality target value Ct to the flow rate calculating unit 19 via the internal bus and the process proceeds to step S104.

In step S104, the flow rate calculating unit 19 sets a supply flow rate Q1 [m³/d] to the bypass pipe 24 to a planned treatment flow rate Qp [m³/d] and sets a supply flow rate Q2 [m³/d] to the sulfate ion removing unit 10 to 0 [m³/d]. That is, the flow rate calculating unit 19 sets a supply amount of the flowing treatment object water including the oil component to the bypass pipe 24 to an entire amount and the process proceeds to step S110. In step S110, the flow rate calculating unit 19 outputs a command value showing the planned treatment flow rate Qp [m³/d] to the flow rate adjusting unit 11a via the output I/F 27 and outputs a command value showing 0 [m³/d] to the flow rate adjusting unit 11b.

Meanwhile, as the determination result in step S103, when the measurement value Cc of the current sulfate ion concentration of the treatment object water is equal to or more than the sulfate ion water quality target value Ct, it is necessary to remove the sulfate ions from the treatment object water including the oil component flowing into the water treatment facility 3, by the sulfate ion removing unit 10. For this reason, the process proceeds to step S105. In step S105, the sulfate ion concentration calculating unit 18 calculates a sulfate ion concentration Ca [mg/L] after the treatment by the sulfate ion removing unit 10 by the following expression (1), on the basis of the removal rate R of the sulfate ion removing unit 10 and the measurement value Cc of the current sulfate ion concentration of the treatment object water obtained by the monitoring unit 7. That is, the sulfate ion concentration calculating unit 18 calculates an amount of the sulfate ion concentration reduced by the treatment of the sulfate ion removing unit 10 with respect to the treatment object water having the sulfate ion concentration Cc and including the oil component. Here, the sulfate ion concentration Ca after the treatment by the sulfate ion removing unit 10 is the prediction value of the sulfate ion concentration in the outflow portion of the sulfate ion removing unit 10.

Ca=(1−R)×Cc (1)

In step S106, the flow rate calculating unit 19 acquires the sulfate ion concentration Ca after the treatment by the sulfate ion removing unit 10, calculated by the sulfate ion concentration calculating unit 18, via the internal bus. In addition, the flow rate calculating unit 19 compares the acquired sulfate ion concentration Ca after the treatment by the sulfate ion removing unit 10 and the sulfate ion water quality target value Ct and determines whether the sulfate ion concentration Ca after the treatment is more than the sulfate ion water quality target value Ct. As a determination result, in the case in which the sulfate ion concentration Ca after the treatment is more than the sulfate ion water quality target value Ct, even if the treatment object water including the oil component flowing into the water treatment facility 3 is supplied entirely to the sulfate ion removing unit 10, the sulfate ion water quality target value Ct cannot be satisfied. For this reason, the process proceeds to step S107. In step S107, the flow rate calculating unit 19 outputs a warning to the display unit 21 via the internal bus and the display unit 21 displays the warning and ends the process. As a result, the operator can immediately grasp a state in which the sulfate ion concentration of the treatment object water including the oil component flowing into the water treatment facility 3 increases due to the change in the water quality and the treatment object water cannot be managed by the sulfate ion removing unit 10 configuring the water treatment facility 3.

Meanwhile, as the determination result in step S106, when the sulfate ion concentration Ca after the treatment by the sulfate ion removing unit 10 is equal to or less than the sulfate ion water quality target value Ct, the flow rate calculating unit 19 sets the supply flow rate Q1 to the bypass pipe 24 and the supply flow rate Q2 to the sulfate ion removing unit 10, respectively, in a range in which Q1+Q2=Qp is satisfied (step S108). For example, the planned treatment flow rate Qp [m³/d] is set as an initial value of the supply flow rate Q1 to the bypass pipe 24 and 0 [m³/d] is set as an initial value of the supply flow rate Q2 to the sulfate ion removing unit 10 and the process proceeds to next step S109.

In step S109, the flow rate calculating unit 19 determines whether the supply flow rate Q1 to the bypass pipe 24 and the supply flow rate Q2 to the sulfate ion removing unit 10, set in step S108, satisfy a relation of the following expression (2).

(Cc×Q1+Ca×Q2)/Qp<Ct (2)

In step S109, when the relation of the expression (2) is not satisfied, the process returns to step S108 and the flow rate calculating unit 19 updates setting values of the supply flow rate Q1 to the bypass pipe 24 and the supply flow rate Q2 to the sulfate ion removing unit 10. Here, when the setting values of the supply flow rate Q1 and the supply flow rate Q2 are updated, the planned treatment flow rate Qp [m³/d] set as the initial value of the supply flow rate Q1 to the bypass pipe 24 is decreased by 10% and the setting value of the supply flow rate Q1 is updated with (Qp−0.1×Qp). In addition, the setting value of the supply flow rate Q2 to the sulfate ion removing unit 10 is updated with (0.1×Qp). In step S109, it is redetermined whether the relation of the expression (2) is satisfied.

As a determination result in step S109, when the relation of the expression (2) is satisfied, the flow rate calculating unit 19 outputs a command value to the flow rate adjusting unit 11a via the internal bus and the output I/F 27, such that the supply flow rate Q1 to the bypass pipe 24 is obtained. Likewise, the flow rate calculating unit 19 outputs a command value to the flow rate adjusting unit 11b via the internal bus and the output I/F 27, such that the supply flow rate Q2 to the sulfate ion removing unit 10 is obtained.

When step S108 and step S109 are repeated, for example, the supply flow rate Q1 to the bypass pipe 24 is updated by decreasing the supply flow by 10% every time and this process is repetitively executed until the relation of the expression (2) is satisfied. As a result, the maximum supply flow rate Q1 to the bypass pipe 24 satisfying the relation of the expression (2) is obtained. In other words, the minimum supply flow rate Q2 to the sulfate ion removing unit 10 satisfying the relation of the expression (2) is obtained. Therefore, the minimum sulfate ions satisfying the sulfate ion water quality target value Ct are treated by the sulfate ion removing unit 10, on the basis of the current sulfate ion concentration Cc of the treatment object water, flowing into the water treatment facility 3 and including the oil component, by the monitoring unit 7. As a result, a load of the sulfate ion removing unit 10 can be reduced and a life of the sulfate ion removing unit 10 can be increased.

In this embodiment, in step S108, the supply flow rate Q1 to the bypass pipe 24 is decreased by 10% every time. However, the present invention is not limited thereto. For example, the supply flow rate Q1 to the bypass pipe 24 may be set as a monotonously decreasing function or may be set as a value decreasing for every predetermined amount.

In addition, in this embodiment, the flow rate calculating unit 19 executes step S106. However, instead of the flow rate calculating unit 19, the sulfate ion concentration calculating unit 18 may execute step S106.

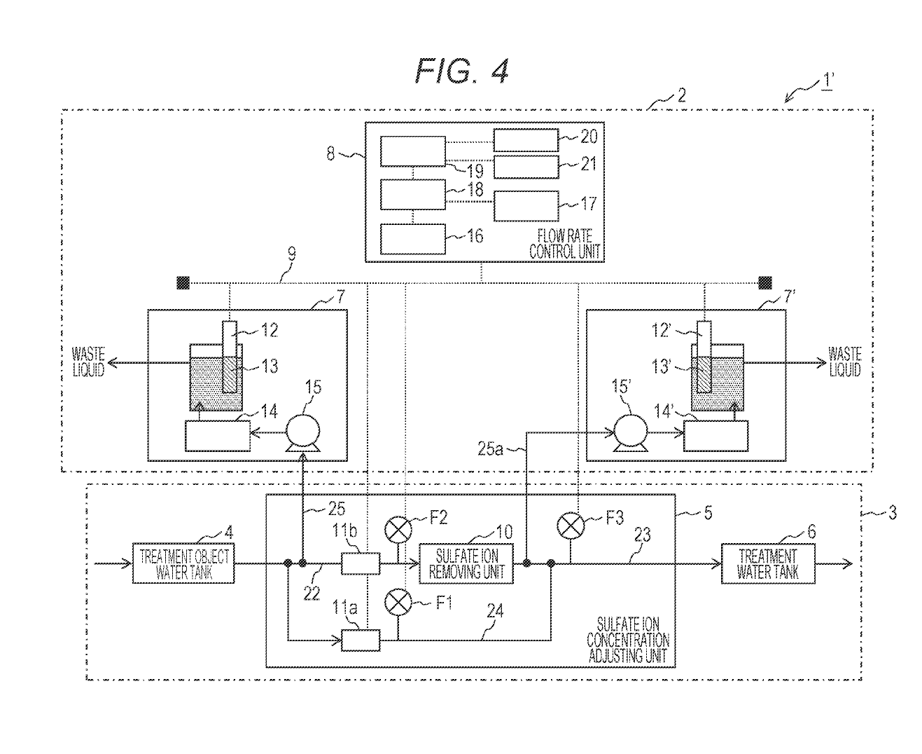

FIG. 4 is a schematic entire configuration diagram of a modification of the water treatment system according to this embodiment. As illustrated in FIG. 4, a water treatment system 1′ includes a monitoring unit 7′ to measure a sulfate ion concentration in an outflow portion of the sulfate ion removing unit 10, that is, a sulfate ion concentration Ca after treatment by the sulfate ion removing unit 10, in addition to the water treatment system 1 illustrated in FIG. 1. As illustrated in FIG. 4, the monitoring unit 7′ includes an electrode 12′ for sulfate ion detection, a sulfate ion selective permeation film 13′, a pretreatment unit 14′, and a sampling pump 15′ attached to a sampling pipe 25a, similar to the monitoring unit 7. A joining portion of the sampling pipe 25a with the outflow pipe 23 is positioned at the outflow side of the sulfate ion removing unit 10 and the upstream side of a joining portion of the bypass pipe 24 with the outflow pipe 23. Thereby, the monitoring unit 7′ introduces only the treatment water after the treatment by the sulfate ion removing unit 10 via the sampling pipe 25a and measures the sulfate ion concentration of the introduced treatment water, that is, the sulfate ion concentration Ca after treatment by the sulfate ion removing unit 10. In FIG. 4, a configuration in which the pretreatment unit 14′ is provided in the monitoring unit 7′ is illustrated. However, similar to the monitoring unit 7, the pretreatment unit 14′ is not essential. In the water treatment system 1′ illustrated in FIG. 4, calculation of the sulfate ion concentration Ca after the treatment by the sulfate ion removing unit 10 in step S105 illustrated in FIG. 3 becomes unnecessary. Therefore, in step S105, the sulfate ion concentration Ca after the treatment by the sulfate ion removing unit 10 is acquired from the monitoring unit 7′ via the network 9. Because the other steps are the same as steps of FIG. 3 described above, description thereof is omitted hereinafter. In the water treatment system 1′ illustrated in FIG. 4, the sulfate ion concentration Ca after the treatment by the sulfate ion removing unit 10 is obtained as an actual measurement value. Therefore, the supply flow rate Q1 to the bypass pipe 24 and the supply flow rate Q2 to the sulfate ion removing unit 10, acquired in step S109 illustrated in FIG. 3, can be calculated with higher precision as compared with the water treatment system 1 illustrated in FIG. 1. However, because the monitoring unit 7′ is further provided as compared with FIG. 1, a facility cost increases.

In this embodiment, the supply flow rate Q2 to the sulfate ion removing unit 10 is set in consideration of only the sulfate ion water quality target value. However, when the sulfate ion removing unit 10 is configured using the film treatment of the NF film or the RO film, a target value of a silt density index (SDI), an organic matter concentration, or turbidity may be set as an index to deteriorate performance thereof and the supply flow rate Q1 to the bypass pipe 24 and the supply flow rate Q2 to the sulfate ion removing unit 10 may be calculated on the basis of the target value. In this case, the monitoring unit 7 may further include an SDI measuring device. When the water quality is determined as a water quality in which suspended solids (substances causing clogging of a film) of the treatment object water including the oil component flowing into the water treatment facility 3 are small, using a measurement value by the SDI measuring device, the supply flow rate of the treatment object water to the sulfate ion removing unit 10 may be increased and the water quality of the treatment water treated by the sulfate ion removing unit 10 may be surely secured.

As described above, according to this embodiment, the sulfate ion concentration of the treatment object water including the oil component is monitored online and the minimum sulfate ions satisfying the sulfate ion water quality target value are treated by the sulfate ion removing unit on the basis of a monitoring result. Therefore, a load of the sulfate ion removing unit can be alleviated and the sulfate ion removing unit can be used over a long period.

In addition, according to this embodiment, a monitoring control device capable of increasing a life of the sulfate ion removing unit to remove the sulfate ions of the treatment object water, a water treatment system including the same, and a water treatment method can be realized.

### Second Embodiment

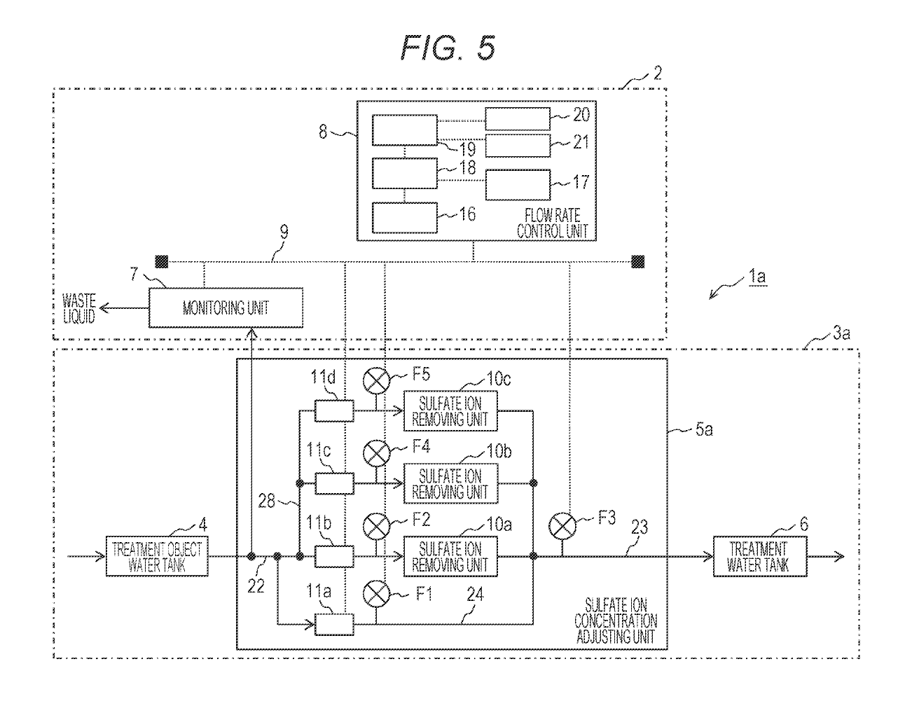

FIG. 5 is a schematic entire configuration diagram of a water treatment system according to a second embodiment of the present invention. This embodiment is different from the first embodiment in that a plurality of sulfate ion removing units are arranged in parallel. In FIG. 5, the same components as those in the first embodiment are denoted with the same reference numerals.

As illustrated in FIG. 5, a water treatment system la includes a water treatment facility 3a and a monitoring control device 2 to control the water treatment facility 3a. Because a configuration of the monitoring control device 2 is the same as the configuration in the first embodiment, overlapped description is omitted hereinafter.

As illustrated in FIG. 5, the water treatment facility 3a has a treatment object water tank 4 to temporarily store treatment object water including an oil component from the upstream side thereof along a flow of the treatment object water including at least the oil component, a sulfate ion concentration adjusting unit 5a to adjust a concentration of sulfate ions of the treatment object water including the oil component, and a treatment water tank 6 to temporarily store treatment water after adjustment of the concentration of the sulfate ions.

The sulfate ion concentration adjusting unit 5a has a plurality of sulfate ion removing units 10a to 10c that are connected to the treatment object water tank 4 via an inflow pipe 22 and a branching pipe 28 and an outflow pipe 23 that supplies the treatment water from which the sulfate ion concentration of the treatment object water has been adjusted by the plurality of sulfate ion removing units 10a to 10c to the treatment water tank 6. Further, the sulfate ion concentration adjusting unit 5a has a bypass pipe 24 that branches off from the inflow pipe 22 at the upstream side of the sulfate ion removing unit 10a and causes the treatment object water to be supplied to the outflow pipe 23 without circulating through the sulfate ion removing unit 10a. A flow meter F1 to measure a flow rate of the treatment object water including the oil component circulating through the bypass pipe 24 is attached to the bypass pipe 24 and a flow rate adjusting unit 11a is provided at the upstream side of the flow meter F1 of the bypass pipe 24. The branching pipe 28 branches off from the inflow pipe 22 at the downstream side of a branching portion of the bypass pipe 24 from the inflow pipe 22. A flow meter F2 to measure a flow rate of the treatment object water including the oil component flowing into the sulfate ion removing unit 10a via the inflow pipe 22 is attached between a branching portion of the branching pipe 28 and the sulfate ion removing unit 10a and a flow rate adjusting unit 11b is provided at the upstream side of the flow meter F2 and the downstream side of the branching portion of the branching pipe 28. In addition, a flow meter F4 to measure a flow rate of the treatment object water including the oil component flowing into the sulfate ion removing unit 10b is provided at the upstream side of the sulfate ion removing unit 10b connected to the branching pipe 28 in parallel to the sulfate ion removing unit 10a and a flow rate adjusting unit 11c is provided at the upstream side of the flow meter F4. Likewise, a flow meter F5 is provided at the upstream side of the sulfate ion removing unit 10c and a flow rate adjusting unit 11d is provided at the upstream side of the flow meter F5. A pipe is laid to cause the treatment water after the treatment by the sulfate ion removing unit 10b and the sulfate ion removing unit 10c to be supplied to a joining portion of the bypass pipe 24 with the outflow pipe 23. A flow meter F3 to measure flow rates of the treatment water from which the sulfate ions have been removed by the sulfate ion removing units 10a to 10c and/or the treatment object water circulating through the bypass pipe 24 and supplied to the treatment water tank 6 is attached to the outflow pipe 23 at the downstream side of the joining portion with the bypass pipe 24.

FIG. 5 illustrates the case in which the sulfate ion removing units disposed in parallel by the inflow pipe 22 and the branching pipe 28 are configured as three systems of the sulfate ion removing units 10a to 10c. However, the present invention is not limited thereto and the sulfate ion removing units disposed in parallel may be configured as a desired number of systems such as two systems and four systems or more. However, in this case, a flow meter and a flow rate adjusting unit are provided for each system.

In this embodiment, the flow rate adjusting units 11b to 11d are controlled such that supply flow rates of the treatment object water including the oil component flowing into the sulfate ion removing units 10a to 10c disposed in parallel become a rated flow rate or zero and control is executed such that a water quality of the treatment water supplied to the treatment water tank 6 satisfies a sulfate ion water quality target value Ct. For this reason, in this embodiment, a running plan storage unit 17 configuring the flow rate control unit 8 stores rated flow rates of the sulfate ion removing units 10a to 10c, in addition to at least a sulfate ion reference value (sulfate ion water quality target value), a treatment amount plan value (planned treatment flow rate), and removal performances (removal rates) of the sulfate ion removing units 10a to 10c, among water quality target values of the treatment water by the sulfate ion concentration adjusting unit 5a, which are previously input by an operator via an input unit 20.

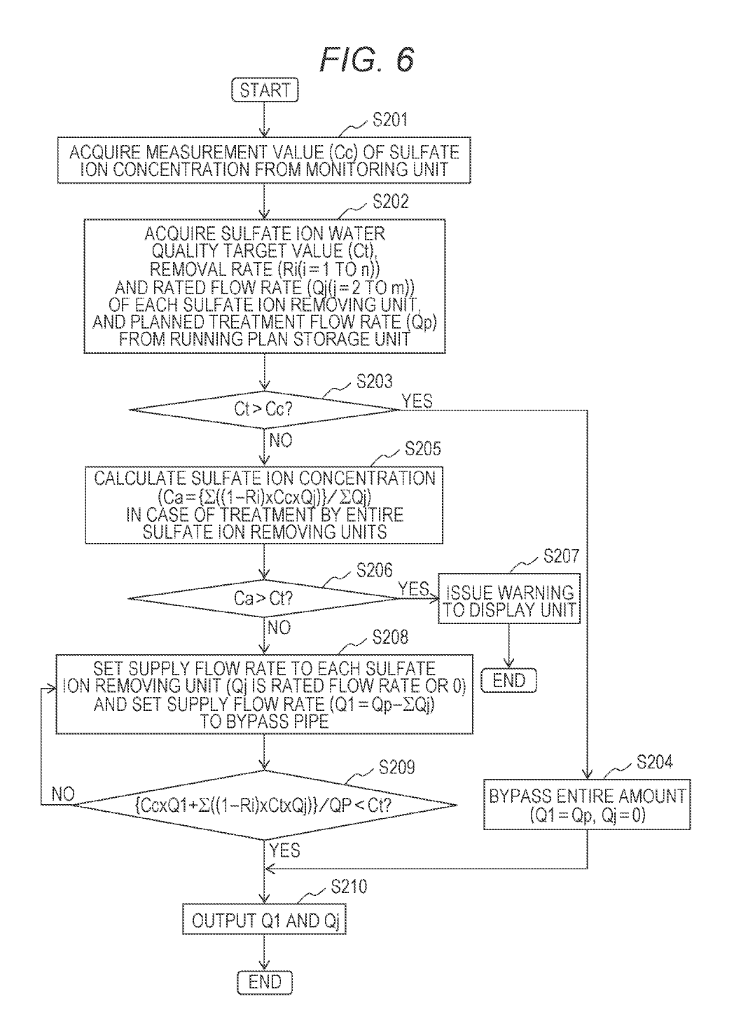

FIG. 6 is a control flow diagram of the water treatment facility 3a by the monitoring control device 2 illustrated in FIG. 5. First, a measurement value acquiring unit 16 configuring the flow rate control unit 8 acquires a measurement value Cc [mg/L] of a current sulfate ion concentration of the treatment object water from the monitoring unit 7 via a network 9 (step S201). Next, a sulfate ion concentration calculating unit 18 configuring the flow rate control unit 8 refers to the running plan storage unit 17 via an internal bus and acquires a sulfate ion water quality target value Ct [mg/L], a removal rate Ri [i=1 to n] of each sulfate ion removing unit, a rated flow rate Qj (j=2 to m) of each sulfate ion removing unit, and a planned treatment flow rate Qp [m³/d] stored in the running plan storage unit 17 (step S202). Here, in the sulfate ion removing units 10a to 10c of the three systems illustrated in FIG. 5 and disposed in parallel, n becomes “3” and m becomes “4”. That is, the sulfate ion removing unit 10a has a removal rate R1 and a rated flow rate Q2, the sulfate ion removing unit 10b has a removal rate R2 and a rated flow rate Q3, and the sulfate ion removing unit 10c has a removal rate R3 and a rated flow rate Q4.

In step S203, the sulfate ion concentration calculating unit 18 compares the sulfate ion water quality target value Ct and the measurement value Cc of the current sulfate ion concentration of the treatment object water and determines whether the measurement value Cc of the current sulfate ion concentration of the treatment object water is less than the sulfate ion water quality target value Ct. As a determination result, if the measurement value Cc of the current sulfate ion concentration is less than the sulfate ion water quality target value Ct, the sulfate ion concentration of the treatment object water satisfies the water quality target value when the treatment object water including the oil component flows into the water treatment facility 3a. Therefore, the treatment by the sulfate ion removing units 10a to 10c becomes unnecessary. For this reason, the sulfate ion concentration calculating unit 18 outputs information showing that the measurement value Cc of the current sulfate ion concentration of the treatment object water is less than the sulfate ion water quality target value Ct to the flow rate calculating unit 19 via the internal bus and the process proceeds to step S204. In step S204, the flow rate calculating unit 19 sets a supply flow rate Q1 [m³/d] to the bypass pipe 24 to the planned treatment flow rate Qp [m³/d] and sets supply flow rates Qj [m³/d] to the sulfate ion removing units 10a to 10c to 0 [m³/d]. That is, the flow rate calculating unit 19 sets a supply amount of the flowing treatment object water including the oil component to the bypass pipe 24 to an entire amount and the process proceeds to step S210. In step S210, the flow rate calculating unit 19 outputs a command value showing the planned treatment flow rate Qp [m³/d] to the flow rate adjusting unit 11a via an output I/F 27 and outputs a command value showing 0 [m³/d] to the flow rate adjusting units 11b to 11d.

Meanwhile, as the determination result in step S203, when the measurement value Cc of the current sulfate ion concentration of the treatment object water is equal to or more than the sulfate ion water quality target value Ct, it is necessary to remove the sulfate ions from the treatment object water including the oil component flowing into the water treatment facility 3a, by the sulfate ion removing units 10a to 10c. For this reason, the process proceeds to step S205. In step S205, the sulfate ion concentration calculating unit 18 calculates a sulfate ion concentration Ca [mg/L] when the treatment object water including the oil component flowing into the water treatment facility 3a is treated entirely by the sulfate ion removing units 10a to 10c, by the following expression (3), on the basis of the removal rates Ri of the sulfate ion removing units 10a to 10c and the measurement value Cc of the current sulfate ion concentration of the treatment object water obtained by the monitoring unit 7.

Ca=(Σ((1−Ri)×Cc×Qj)/ΣQj (3)

Here, Ri=R1 to R3 and Qj=Q2 to Q4 are set. In step S206, the flow rate calculating unit 19 acquires the sulfate ion concentration Ca after the treatment by the sulfate ion removing units 10a to 10c, calculated by the sulfate ion concentration calculating unit 18, via the internal bus. In addition, the flow rate calculating unit 19 compares the acquired sulfate ion concentration Ca after the treatment by the sulfate ion removing units 10a to 10c and the sulfate ion water quality target value Ct and determines whether the sulfate ion concentration Ca after the treatment is more than the sulfate ion water quality target value Ct. As a determination result, in the case in which the sulfate ion concentration Ca after the treatment is more than the sulfate ion water quality target value Ct, even if the treatment object water including the oil component flowing into the water treatment facility 3a is supplied entirely to the sulfate ion removing units 10a to 10c, the sulfate ion water quality target value Ct cannot be satisfied. For this reason, the process proceeds to step S207. In step S207, the flow rate calculating unit 19 outputs a warning to a display unit 21 via the internal bus and the display unit 21 displays the warning and ends the process. As a result, the operator can immediately grasp a state in which the sulfate ion concentration of the treatment object water including the oil component flowing into the water treatment facility 3a increases due to the change in the water quality and the treatment object water cannot be managed by the sulfate ion removing units 10a to 10c configuring the water treatment facility 3a.

Meanwhile, as the determination result in step S206, when the sulfate ion concentration Ca after the treatment by the sulfate ion removing units 10a to 10c is equal to or less than the sulfate ion water quality target value Ct, the flow rate calculating unit 19 sets the supply flow rates Qj (Qj is the rated flow rate or zero) to the sulfate ion removing units 10a to 10c and sets the supply flow rate Q1 to the bypass pipe 24, respectively, in a range in which Q1=Qp−ΣQj is satisfied (step S208). In this embodiment, the three systems of the sulfate ion removing units 10a to 10c are operated individually and the supply flow rate to each of the three systems of the sulfate ion removing units 10a to 10c is the rated flow rate or zero as described above. Therefore, setting of the supply flow rates to the sulfate ion removing units 10a to 10c becomes a combination of rated flow rates and zero. For example, when the supply flow rate to the sulfate ion removing unit 10a is set to the rated flow rate Q2, the supply flow rate to the sulfate ion removing unit 10b is set to the rated flow rate Q3, and the supply flow rate to the sulfate ion removing unit 10c is set to zero, the supply flow rate Q1 to the bypass pipe 24 becomes Q1=Qp−(Q2+Q3).

In step S209, the flow rate calculating unit 19 determines whether the supply flow rate Q1 to the bypass pipe 24 and the supply flow rates Qj to the sulfate ion removing units 10a to 10c, set in step S208, satisfy a relation of the following expression (4).

(Cc×Q1+Σ((1−Ri)×Ct×Qj)}<Ct (4)

In step S209, when the relation of the expression (4) is not satisfied, the process returns to step S208 and the flow rate calculating unit 19 updates setting values of the supply flow rate Q1 to the bypass pipe 24 and the supply flow rates Qj to the sulfate ion removing units 10a to 10c. In step S209, it is redetermined whether the relation of the expression (4) is satisfied. As such, the relation of the expression (4) is satisfied by executing steps S208 and S209 repetitively, a combination of the supply flow rates Qj of the sulfate ion removing units 10a to 10c in which the supply flow rate Q1 to the bypass pipe 24 is maximized is calculated, and the process proceeds to step S210.

In step S210, the flow rate calculating unit 19 outputs a command value to the flow rate adjusting unit 11a via the internal bus and the output I/F 27, such that the supply flow rate Q1 to the bypass pipe 24 is obtained. Likewise, the flow rate calculating unit 19 outputs command values to the flow rate adjusting units 11b to 11d via the internal bus and the output I/F 27, such that the combination of the supply flow rates Qj to the sulfate ion removing units 10a to 10c when the supply flow rate Q1 is maximized is obtained.

In step S208, in the case in which the combination of the supply flow rates Qj to the sulfate ion removing units 10a to 10c of the three systems is set, for example, if priority is allocated to each system on the basis of the length of an operation time, the magnitude of the rated flow rate, a period until a maintenance period, or a performance value of actual sulfate ion removal performance, the repetition number of steps S208 and S209 can be reduced. That is, the combination of the supply flow rates Qj to the sulfate ion removing units 10a to 10c when the supply flow rate Q1 to the bypass pipe 24 is maximized can be calculated in short time. In addition, when the sulfate ion removing unit uses the film treatment of the NF film or the RO film, the priority of the system operating using a differential pressure may be set high.

The allocation of the priority is effective when the number of systems of sulfate ion removing units increases.

According to this embodiment, in addition to the effect according to the first embodiment, even in the water treatment facility including the sulfate ion removing units of the plurality of systems disposed in parallel, the sulfate ion removing unit of each system can be easily controlled such that the sulfate ion water quality target value of the treatment water is satisfied.

In addition, according to this embodiment, control of the water treatment facility 3a is enabled only by operating (the supply flow rate is the rated flow rate) or stopping (the supply flow rate is zero) the sulfate ion removing units of the plurality of systems disposed in parallel. Therefore, loads of the sulfate ion removing units of the individual systems can be distributed or averaged and a life of the individual sulfate ion removing units can be increased.

### Third Embodiment

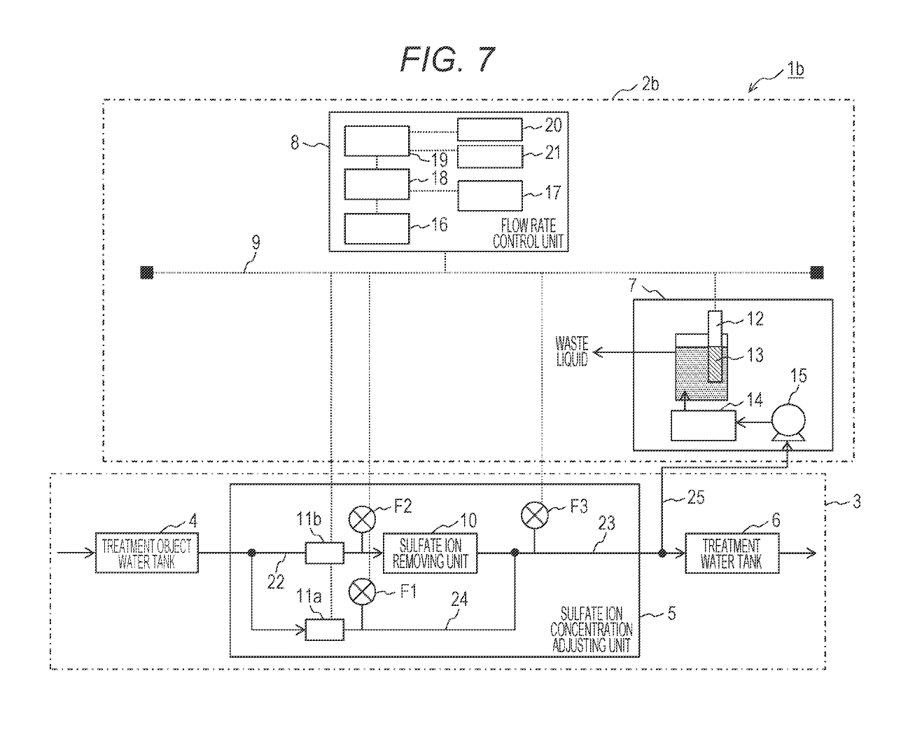

FIG. 7 is a schematic entire configuration diagram of a water treatment system according to a third embodiment of the present invention. This embodiment is different from the first embodiment in that a monitoring unit is disposed to measure a sulfate ion concentration of treatment water flowing into a treatment water tank from a sulfate ion concentration adjusting unit. In FIG. 7, the same components as those in the first embodiment are denoted with the same reference numerals. Description overlapped to the description of the first embodiment is omitted hereinafter.

As illustrated in FIG. 7, a water treatment system lb according to this embodiment includes a water treatment facility 3 and a monitoring control device 2b to control the water treatment facility 3. A sampling pipe 25 is laid to branch off from an outflow pipe 23 between a sulfate ion concentration adjusting unit 5 and a treatment water tank 6 and introduce a part of treatment water after treatment by the sulfate ion concentration adjusting unit 5 to a monitoring unit 7. Similar to the first embodiment, the monitoring unit 7 includes an electrode 12 for sulfate ion detection, a sulfate ion selective permeation film 13, a pretreatment unit 14, and a sampling pump 15 attached to the sampling pipe 25. A flow rate control unit 8 calculates a supply flow rate Q1 [m³/d] of treatment object water flowing into the water treatment facility 3 to a bypass pipe 24 by feedback control, on the basis of a sulfate ion concentration Cb [mg/L] of the treatment water treated by the sulfate ion concentration adjusting unit 5, which is acquired from the monitoring unit 7 via a network 9. A measurement value acquiring unit 16 configuring the flow rate control unit 8 acquires the measured current sulfate ion concentration Cb of the treatment water from the monitoring unit 7 via the network 9, an input I/F 26, and an internal bus (refer to FIG. 2). A flow rate calculating unit 19 configuring, the flow rate control unit 8 refers to a running plan storage unit 17 (refer to FIG. 2) via the internal bus and acquires a sulfate ion water quality target value Ct [mg/L] previously stored in the running plan storage unit 17. Then, the flow rate calculating unit 19 directly compares the current sulfate ion concentration Cb of the treatment water and the sulfate ion water quality target value Ct. When the current sulfate ion concentration Cb of the treatment water is more than the sulfate ion water quality target value Ct, a supply flow rate of the treatment object water including an oil component to a sulfate ion removing unit 10 is increased. Meanwhile, when the current sulfate ion concentration Cb of the treatment water is equal to or less than the sulfate ion water quality target value Ct, the flow rate calculating unit 19 increases the supply flow rate of the treatment object water including the oil component to the bypass pipe 24. Here, an increase amount of the supply flow rate of the treatment object water to the sulfate ion removing unit 10 and an increase amount of the supply flow rate of the treatment object water to the bypass pipe 24 are calculated on the basis of a removal rate R of the sulfate ion removing unit 10 previously stored in the running plan storage unit 17, according to a difference of the current sulfate ion concentration Cb of the treatment water and the sulfate ion water quality target value Ct.

The feedback control using the measured current sulfate ion concentration Cb of the treatment water is executed by applying known PI control or PID control.

In this embodiment, the monitoring unit 7 is used only for measuring the sulfate ion concentration Cb of the treatment water. However, a sulfate ion concentration Cc of the treatment object water flowing into the sulfate ion removing unit 10 via an inflow pipe 22 and including the oil component may be measured simultaneously by the monitoring unit 7, by a combination with the configuration according to the first embodiment. By this configuration, a combination of feed forward control and feedback control is enabled and stable control of the water treatment facility is enabled.

According to this embodiment, in addition to the effect according to the first embodiment, because the sulfate ion concentration of the treatment water is directly measured and is fed back, stable water quality management capable of satisfying a target water quality surely is enabled.

### Fourth Embodiment

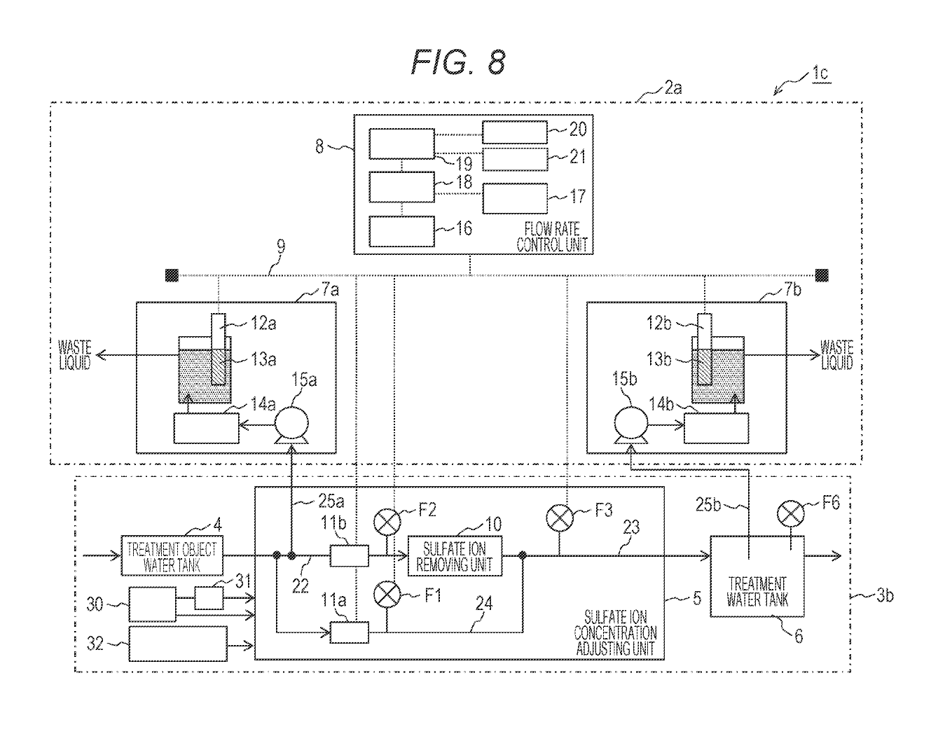

FIG. 8 is a schematic entire configuration diagram of a water treatment system according to a fourth embodiment of the present invention. This embodiment is different from the first embodiment in that a monitoring unit is disposed additionally in a treatment water tank and a power supply facility 30 using reproducible energy, an energy storage unit 31, and a conventional power supply facility 32 are provided to supply power to a sulfate ion concentration adjusting unit. In FIG. 8, the same components as those in the first embodiment are denoted with the same reference numerals. Description overlapped to the description of the first embodiment is omitted hereinafter.

As illustrated in FIG. 8, a water treatment system 1c according to this embodiment includes a water treatment facility 3b and a monitoring control device 2a to control the water treatment facility 3b. The water treatment facility 3b includes the power supply facility 30 using the reproducible energy, the energy storage unit 31, and the conventional power supply facility 32 to supply power to pumps configuring flow rate adjusting units 11a and 11b in a sulfate ion concentration adjusting unit 5. In addition, the monitoring control device 2a includes a monitoring unit 7a that measures a sulfate ion concentration of treatment object water including an oil component circulating through an inflow pipe 22 and a monitoring unit 7b that measures a sulfate ion concentration of treatment water stored in a treatment water tank 6. In addition, a flow meter F6 to measure a flow rate of treatment water supplied for a posttreatment for injecting the treatment water into an oil layer from the treatment water tank 6 is disposed in the treatment water tank 6. The monitoring unit 7a includes an electrode 12a for sulfate ion detection, a sulfate ion selective permeation film 13a, a pretreatment unit 14a, and a sampling pump 15a attached to a sampling pipe 25a. Likewise, the monitoring unit 7b includes an electrode 12b for sulfate ion detection, a sulfate ion selective permeation film 13b, a pretreatment unit 14b, and a sampling pump 15b attached to a sampling pipe 25b. The sampling pipe 25a branches off from the inflow pipe 22 at the upstream side of the flow rate adjusting unit 11b and introduces a part of treatment object water including an oil component into the monitoring unit 7a. In addition, the sampling pipe 25b has one end immersed in the treatment water stored in the treatment water tank 6 and introduces a part of the treatment water in the treatment water tank 6 into the monitoring unit 7b.

The power supply facility 30 using the reproducible energy is a photovoltaic facility, for example. The power supply facility 30 supplies generated power to the pump in the sulfate ion concentration adjusting unit 5 and supplies the generated power to the energy storage unit 31 to store electricity. Meanwhile, the conventional power supply facility 32 can stably supply power from a thermal power station or a nuclear power station, on the basis of an agreement with an electric power company.

Because the flow rate adjusting unit 11b provided in the inflow pipe 22 causes the treatment object water including the oil component to pass through the sulfate ion removing unit 10, the flow rate adjusting unit 11b has high pressure loss as compared with the flow rate adjusting unit 11a provided in a bypass pipe 24 and has a large energy consumption amount. For this reason, when the flow rate adjusting unit 11b is used, power is supplied preferentially from the power supply facility 30 using the reproducible energy and insufficient power is supplied from the conventional power supply facility 32. When an amount of power supplied from the power supply facility 30 using the reproducible energy does not reach a predetermined amount, power is supplied from the energy storage unit 31.

When only the flow rate adjusting unit 11a runs, that is, the treatment object water including the oil component is supplied entirely to the bypass pipe 24, power generated from the power supply facility 30 using the reproducible energy is first supplied to the energy storage unit 31. When an amount of storage in the energy storage unit 31 is more than a predetermined value, power corresponding to an entire amount of power generated from the power supply facility 30 using the reproducible energy and an insufficient amount is supplied from the conventional power supply facility 32 to the sulfate ion concentration adjusting unit 5.

A supply flow rate Q1 of the treatment object water including the oil component to the bypass pipe 24 and a supply flow rate Q2 of the treatment object water to the sulfate ion removing unit 10, controlled by the flow rate control unit 8, are calculated by a flow rate calculating unit 19 configuring the flow rate control unit 8, similar the control flow illustrated in FIG. 3. The flow rate control unit 8 executes feed forward control based on a current sulfate ion concentration Cc of the treatment object water including the oil component, measured by the monitoring unit 7a, and a feedback control based on a current sulfate ion concentration of the treatment water stored in the treatment water tank 6, measured by the monitoring unit 7b.

In this embodiment, in addition to the effect according to the first embodiment, an external power purchase cost necessary for removing sulfate ions can be reduced by using the power supply facility using the reproducible energy and the energy storage unit. That is, an energy cost relating to sulfate ion removal can be reduced.

### Fifth Embodiment

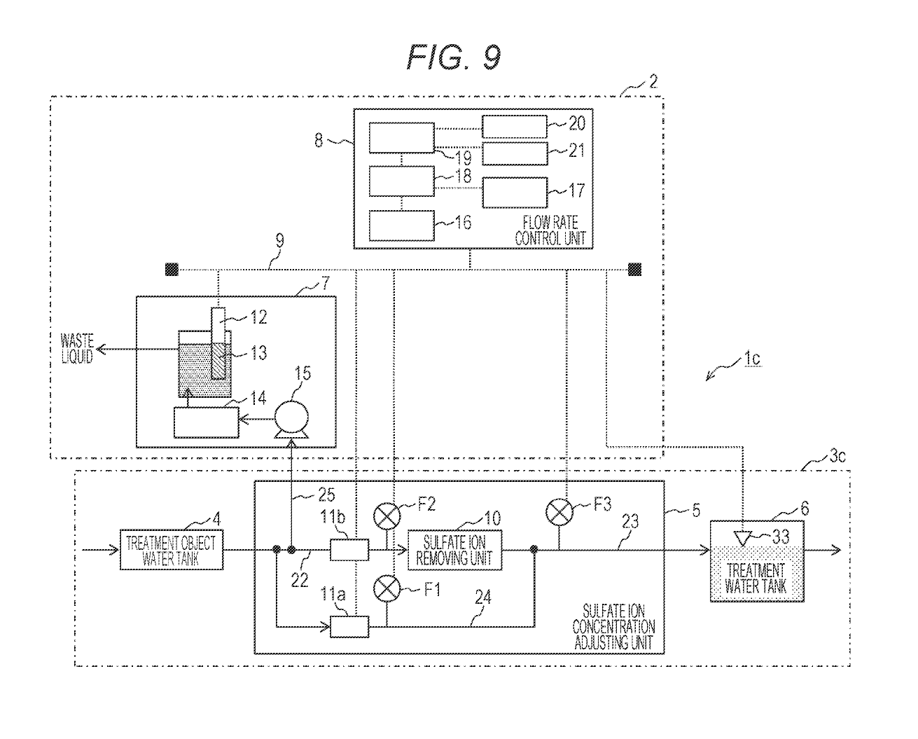

FIG. 9 is a schematic entire configuration diagram of a water treatment system according to a fifth embodiment of the present invention. This embodiment is different from the first embodiment in that a water level indicator to measure a level of treatment water stored in a treatment water tank is provided. In FIG. 9, the same components as those in the first embodiment are denoted with the same reference numerals. Description overlapped to the description of the first embodiment is omitted hereinafter.

As illustrated in FIG. 9, a water treatment system 1c according to this embodiment includes a water treatment facility 3c and a monitoring control device 2 to control the water treatment facility 3c. The water treatment facility 3c includes a water level indicator 33 that is provided in a treatment water tank 6 into which treatment water from which a sulfate ion concentration of treatment object water including an oil component has been adjusted by a sulfate ion concentration adjusting unit 5 is introduced via an outflow pipe 23. Here, a water level indicator of a floating type, a water level indicator of a supersonic wave irradiation type, or a water level indicator of a capacitance detection type is used as an example of the water level indicator 33. A level of the treatment water in the treatment water tank 6 measured by the water level indicator 33 is transmitted to a flow rate control unit 8 via a network 9.

A running plan storage unit 17 (refer to FIG. 2) configuring the flow rate control unit 8 previously stores a water level upper limit setting value H and a water level lower limit setting value L, in addition to a sulfate ion water quality target value Ct, a removal rate R of a sulfate ion removing unit 10, and a planned treatment flow rate Qp. Information stored in the running plan storage unit 17 is previously stored in the running plan storage unit 17 via an input unit 20 (refer to FIG. 2) and an internal bus by an operator.

First, a flow rate calculating unit 19 (refer to FIG. 2) configuring the flow rate control unit 8 refers to the running plan storage unit 17 via the internal bus and acquires the water level upper limit setting value H, the water level lower limit setting value L, the sulfate ion water quality target value Ct, and the planned treatment flow rate Qp stored in the running plan storage unit 17. In addition, a measurement value acquiring unit 16 (refer to FIG. 2) configuring the flow rate control unit 8 acquires a measurement value Cc of a current sulfate ion concentration of the treatment object water including the oil component, which is measured by a monitoring unit 7, via the network 9. In addition, the measurement value acquiring unit 16 outputs the acquired measurement value Cc of the current sulfate ion concentration of the treatment object water to the flow rate calculating unit 19 via the internal bus.

The flow rate calculating unit 19 compares the measurement value Cc of the current sulfate ion concentration of the treatment object water and the sulfate ion water quality target value Ct and determines whether the measurement value Cc of the current sulfate ion concentration of the treatment object water is less than the sulfate ion water quality target value Ct. As a determination result, in the case in which the measurement value Cc of the current sulfate ion concentration of the treatment object water is less than the sulfate ion water quality target value Ct, the sulfate ion concentration of the treatment object water satisfies the sulfate ion water quality target value Ct when the treatment object water including the oil component flows into the water treatment facility 3c. Therefore, the flow rate calculating unit 19 sets a supply flow rate Q1 to a bypass pipe 24 to a planned treatment flow rate Qp [m³/d] and sets a supply flow rate Q2 to the sulfate ion removing unit 10 to 0 [m³/d]. In addition, the flow rate calculating unit 19 outputs a command value causing the supply flow rate Q2 to the sulfate ion removing unit 10 to become 0 [m³/d] to a flow rate adjusting unit 11b via an output I/F 27 (refer to FIG. 2) and the network 9. In addition, the flow rate calculating unit 19 outputs a command value causing the supply flow rate Q2 to the bypass pipe 24 to become the planned treatment flow rate Qp [m³/d] to a flow rate adjusting unit 11a via the output I/F 27 and the network 9. As a result, the treatment object water including the oil component flowing into the water treatment facility 3c is bypassed entirely to the bypass pipe 24. At this time, when the treatment object water of the flow rate Q1 (Qp) flows into the treatment water tank 6 via the bypass pipe 24 and the outflow pipe 23, the flow rate calculating unit 19 executes control such that a water level in the treatment water tank 6 becomes equal to or less than the water level upper limit setting value H.

Specifically, a capacity, a horizontal cross-section area, and a height of the treatment water tank 6 are already known and a level of the treatment water in the treatment water tank 6 when the flow rate calculating unit 19 acquires the supply flow rate Q1 to the bypass pipe 24 and the supply flow rate Q2 to the sulfate ion removing unit 10 is measured by the water level indicator 33. The water level measured by the water level indicator 33 is acquired by the measurement value acquiring unit 16 via the network 9 and the input I/F 26 and the acquired water level measured by the water level indicator 33 is output to the flow rate calculating unit 19 via the internal bus. The flow rate calculating unit 19 can easily calculate an available capacity Qv until the water level of the treatment water tank 6 reaches the water level upper limit setting value H, on the basis of the current measured water level in the treatment water tank 6 and the water level upper limit setting value H. Therefore, if the supply flow rate Q1 (Qp) is more than the available capacity Qv in the treatment water tank 6 when the supply flow rate Q1 to the bypass pipe 24 is set to Qp, the flow rate calculating unit 19 corrects Qp set as the supply flow rate Q1 to the bypass pipe 24 with the available capacity Qv in the treatment water tank 6 and the water level in the treatment water tank 6 is maintained within the water level upper limit setting value H. In contrast, when the previously stored planned treatment flow rate Qp is equal to or less than the available capacity Qv of the treatment water tank 6, the flow rate calculating unit 19 may set the available capacity Qv of the treatment water tank 6 to the supply flow rate Q1 to the bypass pipe 24 and set the supply flow rate Q2 to the sulfate ion removing unit 10 to 0 [m³/d]. As such, the flow rate is distributed, so that the treatment water of a flow rate larger than the planned treatment flow rate Qp can be supplied to the treatment water tank 6 and can be stored in the treatment water tank 6, during a period in which the sulfate ion concentration of the treatment object water including the oil component flowing into the water treatment facility 3c is less than the sulfate ion water quality target value Ct.

Meanwhile, when the measurement value Cc of the current sulfate ion concentration of the treatment object water is equal to or more than the sulfate ion water quality target value Ct and the measured water level of the treatment water tank 6 is more than the water level lower limit setting value L, a flow rate of a flow meter F3 attached to the outflow pipe 23 is set to a value (Q3) equal to or more than zero and less than the planned treatment flow rate Qp. For example, Q3=0.5×Qp is set. In addition, in a flow rate Q3, the flow rate calculating unit 19 sets a supply flow rate Q1′ to the bypass pipe 24 and a supply flow rate Q2′ to the sulfate ion removing unit 10, such that a sulfate ion concentration Ca after the treatment by the sulfate ion removing unit 10 becomes less than the sulfate ion water quality target value Ct, similar to the case of the first embodiment. Here, the flow rate calculating unit 19 calculates maximum Q1′ satisfying a relation of Q3=Q1′+Q2′ and Q2′ at that time.

According to this embodiment, in addition to the effect according to the first embodiment, the treatment water of a flow rate larger than a flow rate (planned treatment flow rate) necessary for EOR can be supplied to the treatment water tank and can be buffered in the treatment water tank, during a period in which the sulfate ion concentration of the treatment object water including the oil component flowing into the water treatment facility is less than the water quality target value. As a result, even when the sulfate ion concentration of the treatment object water including the oil component increases, the supply flow rate to the sulfate ion removing unit can be further reduced.

The present invention is not limited to the embodiments described above and various modifications are included in the present invention. For example, the embodiments are described in detail to facilitate the description of the present invention and the present invention is not limited to embodiments in which all of the described configurations are included. In addition, a part of the configurations of the certain embodiment can be replaced by the configurations of other embodiments or the configurations of other embodiments can be added to the configurations of the certain embodiment. In addition, for a part of the configurations of the individual embodiments, addition, removal, and replacement of the configurations of other embodiments can be performed.

What is claimed is:

1. A water treatment system comprising:
a water treatment facility which includes a sulfate ion removing unit removing sulfate ions of treatment object water introduced from an inflow pipe and including at least an oil component and supplying treatment water after removing the sulfate ions to an outflow pipe and a bypass pipe branching off from the inflow pipe and causing the treatment object water including the oil component to circulate through the outflow pipe; and
a monitoring control device which includes a monitoring unit measuring a sulfate ion concentration of the treatment object water including the oil component and/or a sulfate ion concentration of the treatment water circulating through the outflow pipe and a flow rate control unit controlling a supply flow rate of the treatment object water to the sulfate ion removing unit and a supply flow rate of the treatment object water to the bypass pipe, wherein
the flow rate control unit calculates the supply flow rate of the treatment object water to the sulfate ion removing unit and the supply flow rate of the treatment object water to the bypass pipe, on the basis of the sulfate ion concentration obtained by the monitoring unit.

2. The water treatment system according to claim 1, wherein
the flow rate control unit includes a running plan storage unit which previously stores at least a sulfate ion water quality target value and a planned treatment flow rate, and a flow rate calculating unit which calculates the supply flow rate of the treatment object water to the sulfate ion removing unit and the supply flow rate of the treatment object water to the bypass pipe, on the basis of the sulfate ion concentration obtained by the monitoring unit and the sulfate ion water quality target value and the planned treatment flow rate stored in the running plan storage unit.

3. The water treatment system according to claim 2, wherein
the monitoring unit has at least a sulfate ion selective permeation film selectively permeating the sulfate ions from the treatment object water including the oil component and/or the treatment water circulating through the outflow pipe and an electrode for sulfate ion detection.

4. The water treatment system according to claim 3, wherein
the monitoring unit includes a pretreatment unit which separates at least the oil component from the treatment object water including the oil component and/or the treatment water circulating through the outflow pipe.

5. The water treatment system according to claim 3, wherein
the water treatment facility includes a first flow rate adjusting unit which is provided in the inflow pipe and a second flow rate adjusting unit which is provided in the bypass pipe; and
the flow rate calculating unit controls the first flow rate adjusting unit such that the calculated supply flow rate of the treatment object water to the sulfate ion removing unit is obtained and controls the second flow rate adjusting unit such that the calculated supply flow rate of the treatment object water to the bypass pipe is obtained.

6. The water treatment system according to claim 5, wherein
the monitoring unit measures a sulfate ion concentration of the treatment object water including the oil component introduced from a sampling pipe branching off from the inflow pipe at the upstream side of the first flow rate adjusting unit;
the flow rate control unit further stores a removal rate to be removal performance of the sulfate ion removing unit in the running plan storage unit and includes a sulfate ion concentration calculating unit which calculates a sulfate ion concentration after treatment by the sulfate ion removing unit, on the basis of the removal rate of the sulfate ion removing unit and the sulfate ion concentration of the treatment object water measured by the monitoring unit; and
the flow rate calculating unit calculates the supply flow rate of the treatment object water to the sulfate ion removing unit and the supply flow rate of the treatment object water to the bypass pipe, on the basis of the sulfate ion water quality target value, the planned treatment flow rate, the sulfate ion concentration of the treatment object water obtained by the monitoring unit, and the sulfate ion concentration after the treatment by the sulfate ion removing unit, obtained by the sulfate ion concentration calculating unit.

7. The water treatment system according to claim 6, wherein
the water treatment facility further includes a plurality of sulfate ion removing units connected in parallel to a branching pipe branching off from the inflow pipe at the upstream side of the first flow rate adjusting unit and the downstream side of a branching portion of the bypass pipe and a plurality of flow rate adjusting units provided to correspond to the plurality of sulfate ion removing units connected in parallel; and
the flow rate calculating unit calculates a supply flow rate of the treatment object water to each sulfate ion removing unit and a supply flow rate of the treatment object water to the bypass pipe.

8. The water treatment system according to claim 5, wherein
the monitoring control device includes a first monitoring unit which measures a sulfate ion concentration of the treatment object water including the oil component introduced from a first sampling pipe branching off from the inflow pipe at the upstream side of the first flow rate adjusting unit, and a second monitoring unit which measures a sulfate ion concentration of the treatment water introduced from a second sampling pipe disposed to branch off from the upstream side of a joining portion with the bypass pipe in the outflow pipe or have one end immersed in the treatment water in a treatment water tank storing the treatment water from the outflow pipe; and
the flow rate calculating unit calculates the supply flow rate of the treatment object water to the sulfate ion removing unit and the supply flow rate of the treatment object water to the bypass pipe, on the basis of the sulfate ion water quality target value, the planned treatment flow rate, the sulfate ion concentration of the treatment object water obtained by the first monitoring unit, and the sulfate ion concentration of the treatment water obtained by the second monitoring unit.

9. The water treatment system according to claim 8, wherein
the water treatment facility includes at least a power supply facility using reproducible energy and a conventional power supply facility to supply power to the first flow rate adjusting unit and the second flow rate adjusting unit and an energy storage unit to store power generated from the power supply facility using the reproducible energy; and
when the power is supplied to the first flow rate adjusting unit, the power generated from the power supply facility using the reproducible energy is supplied preferentially.

10. The water treatment system according to claim 6, wherein
the water treatment facility includes a treatment water tank which stores the treatment water from the outflow pipe and a water level indicator which measures a level of the treatment water in the treatment water tank;
the running plan storage unit stores a water level upper limit setting value and a water level lower limit setting value; and
when the sulfate ion concentration of the treatment object water measured by the monitoring unit is less than the sulfate ion water quality target value, the flow rate calculating unit sets a supply flow rate of the treatment object water to the bypass pipe to an available capacity of the treatment water tank based on the water level measured by the water level indicator or the planned treatment flow rate.

11. The water treatment system according to claim 6, wherein
the flow rate control unit has a display unit; and
when the sulfate ion concentration after the treatment by the sulfate ion removing unit, obtained by the sulfate ion concentration calculating unit, is more than the sulfate ion water quality target value, the flow rate control unit displays a warning on the display unit.

12. A monitoring control device for controlling a water treatment facility including a sulfate ion removing unit removing sulfate ions of treatment object water introduced from an inflow pipe and including at least an oil component and supplying treatment water after removing the sulfate ions to an outflow pipe and a bypass pipe branching off from the inflow pipe and causing the treatment object water including the oil component to circulate through the outflow pipe, the monitoring control device comprising:
a monitoring unit which measures a sulfate ion concentration of the treatment object water including the oil component and/or a sulfate ion concentration of the treatment water circulating through the outflow pipe; and
a flow rate control unit which controls a supply flow rate of the treatment object water to the sulfate ion removing unit and a supply flow rate of the treatment object water to the bypass pipe, wherein
the flow rate control unit calculates the supply flow rate of the treatment object water to the sulfate ion removing unit and the supply flow rate of the treatment object water to the bypass pipe, on the basis of the sulfate ion concentration obtained by the monitoring unit.

13. The monitoring control device according to claim 12, wherein
the flow rate control unit includes a running plan storage unit which previously stores at least a sulfate ion water quality target value and a planned treatment flow rate and a flow rate calculating unit which calculates the supply flow rate of the treatment object water to the sulfate ion removing unit and the supply flow rate of the treatment object water to the bypass pipe, on the basis of the sulfate ion concentration obtained by the monitoring unit and the sulfate ion water quality target value and the planned treatment flow rate stored in the running plan storage unit.

14. The monitoring control device according to claim 13, wherein
the monitoring unit has at least a sulfate ion selective permeation film selectively permeating the sulfate ions from the treatment object water including the oil component and/or the treatment water circulating through the outflow pipe and an electrode for sulfate ion detection.

15. The monitoring control device according to claim 14, wherein
the monitoring unit includes a pretreatment unit which separates at least the oil component from the treatment object water including the oil component and/or the treatment water circulating through the outflow pipe.

16. The monitoring control device according to claim 15, wherein
the monitoring unit measures a sulfate ion concentration of the treatment object water including the oil component introduced from a sampling pipe branching off from the inflow pipe;
the flow rate control unit further stores a removal rate to be removal performance of the sulfate ion removing unit in the running plan storage unit and includes a sulfate ion concentration calculating unit which calculates a sulfate ion concentration after treatment by the sulfate ion removing unit, on the basis of the removal rate of the sulfate ion removing unit and the sulfate ion concentration of the treatment object water measured by the monitoring unit; and
the flow rate calculating unit calculates the supply flow rate of the treatment object water to the sulfate ion removing unit and the supply flow rate of the treatment object water to the bypass pipe, on the basis of the sulfate ion water quality target value, the planned treatment flow rate, the sulfate ion concentration of the treatment object water obtained by the monitoring unit, and the sulfate ion concentration after the treatment by the sulfate ion removing unit, obtained by the sulfate ion concentration calculating unit.

17. The monitoring control device according to claim 16, further comprising:
a first monitoring unit which measures a sulfate ion concentration of the treatment object water including the oil component introduced from a first sampling pipe branching off from the inflow pipe; and
a second monitoring unit which measures a sulfate ion concentration of the treatment water introduced from a second sampling pipe disposed to branch off from the upstream side of a joining portion with the bypass pipe in the outflow pipe or have one end immersed in the treatment water in a treatment water tank storing the treatment water from the outflow pipe, wherein
the flow rate calculating unit calculates a supply flow rate of the treatment object water to the sulfate ion removing unit and a supply flow rate of the treatment object water to the bypass pipe, on the basis of the sulfate ion water quality target value, the planned treatment flow rate, the sulfate ion concentration of the treatment object water obtained by the first monitoring unit, and the sulfate ion concentration of the treatment water obtained by the second monitoring unit.

18. The monitoring control device according to claim 16, wherein
the flow rate control unit has a display unit; and
when the sulfate ion concentration after the treatment by the sulfate ion removing unit, obtained by the sulfate ion concentration calculating unit, is more than the sulfate ion water quality target value, the flow rate control unit displays a warning on the display unit.

19. A water treatment method for a water treatment facility including a sulfate ion removing unit removing sulfate ions of treatment object water introduced from an inflow pipe and including at least an oil component and supplying treatment water after removing the sulfate ions to an outflow pipe and a bypass pipe branching off from the inflow pipe and causing the treatment object water including the oil component to circulate through the outflow pipe, the water treatment method comprising:
measuring a sulfate ion concentration of the treatment object water including the oil component and/or a sulfate ion concentration of the treatment water circulating through the outflow pipe; and
calculating a supply flow rate of the treatment object water to the sulfate ion removing unit and a supply flow rate of the treatment object water to the bypass pipe, on the basis of the measured sulfate ion concentration.

20. The water treatment method according to claim 19, wherein
at least a sulfate ion water quality target value and a planned treatment flow rate are previously stored; and
the supply flow rate of the treatment object water to the sulfate ion removing unit and the supply flow rate of the treatment object water to the bypass pipe are calculated on the basis of the measured sulfate ion concentration, the sulfate ion water quality target value, and the planned treatment flow rate.
